(19) United States
(12) Patent Application Publication
(10) Pub. No.: US 2018/0375674 A1
(43) Pub. Date: Dec. 27, 2018

(54) JUDGEMENT UNIT AND CONTROLLING METHOD THEREOF, POWER SUPPLY DEVICE AND CONTROLLING METHOD THEREOF

(71) Applicant: DELTA ELECTRONICS, INC., Taoyuan City (TW)

(72) Inventors: Kuan-Hsien TU, Taoyuan City (TW); Yung-Wei PENG, Taoyuan City (TW); So-Huan CHIANG, Taoyuan City (TW)

(21) Appl. No.: 15/803,862

(22) Filed: Nov. 6, 2017

(30) Foreign Application Priority Data
Jun. 22, 2017 (CN) 201710481204.5

(51) Int. Cl. H04L 12/10

(52) U.S. Cl. CPC H04L 12/10

(57) ABSTRACT

A judgement unit applied in a Power over Ethernet (PoE) device is disclosed herein. The judgement unit is configured to determine whether the PoE device is coupled to a load. If the judgement unit determines that the PoE device is not coupled to the load, a definite time handshaking activation signal is outputted for activating a definite time handshaking communication mode of the PoE device so as to communicate with the load in a definite time handshaking manner.

### RELATED APPLICATIONS

This application claims priority to China Application Serial Number 201710481204.5, filed Jun. 22, 2017, which is herein incorporated by reference.

### BACKGROUND

### Field of Invention

The present invention relates to an electronic device and a controlling method thereof. More particularly, the present invention relates to a judgement unit and a controlling method thereof, and a power supply device and a controlling method thereof.

### Description of Related Art

Since power sourcing equipment (PSE) with conventional circuit design need to communicate with powered devices (PD) in a full time handshaking manner for determining whether to provide power for the target PD by the PSE, the PSE will continuously consume power when the PD is disconnected with the PSE. Therefore, conventional PSE used in Ethernet cannot confirm standard of power consumption acquired by the Department of Energy (DoE).

Controller of conventional PSE which communicates with PD in a full time handshaking manner will continuously consume power when the PD is disconnected with the PSE. Hence, conventional PSE cannot confirm standard of power consumption with no load power acquired by the DoE.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a judgement unit applied in a Power over Ethernet (PoE) device. The judgement unit is configured to determine whether the PoE device is coupled to a load. If the judgement unit determines that the PoE device is not coupled to the load, a definite time handshaking activation signal is outputted for activating a definite time handshaking communication mode of the PoE device so as to communicate with the load in a definite time handshaking manner.

Another aspect of the present disclosure is directed to a power supply device for providing power to a load. The power supply device comprises a judgement unit and a controller. The judgement unit is configured to determine whether the power supply device is coupled to the load. If the judgement unit determines that the power supply device is not coupled to the load, a definite time handshaking activation signal is outputted. The controller is coupled to the judgement unit. If the controller receives the definite time handshaking activation signal outputted by the judgement unit, the controller adopts a definite time handshaking communication mode so as to communicate with the load in a definite time handshaking manner.

Still another aspect of the present disclosure is directed to a control method of a judgement unit applied in a Power over Ethernet (PoE) device. The control method comprises steps of: determining whether the PoE device is coupled to a load by a judgement unit; and outputting a definite time handshaking activation signal for activating a definite time handshaking communication mode of the PoE device so as to communicate with the load in a definite time handshaking manner if the judgement unit determines that the PoE device is not coupled to the load.

Yet another aspect of the present disclosure is directed to a control method of a power supply device. The power supply device is configured to provide power to a load. The power supply device comprises a judgement unit and a controller. The judgement unit is coupled to the controller. The control method comprises steps of: determining whether the power supply device is coupled to the load by the judgement unit; outputting a definite time handshaking activation signal if the judgement unit determines that the power supply device is not coupled to the load; and adopting a definite time handshaking communication mode by the controller so as to communicate with the load in a definite time handshaking manner if the controller receives the definite time handshaking activation signal outputted by the judgement unit.

In view of the foregoing, embodiments of the present disclosure provide a judgement unit and a controlling method thereof, a power supply device and a controlling method thereof so as to confirm standard of power consumption acquired by the Department of Energy (DoE) when a load is disconnected with the power supply device.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a block diagram of a power supply device according to embodiments of the present invention.

FIG. 2 is a flow diagram illustrating process steps of a method for controlling a power supply device according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

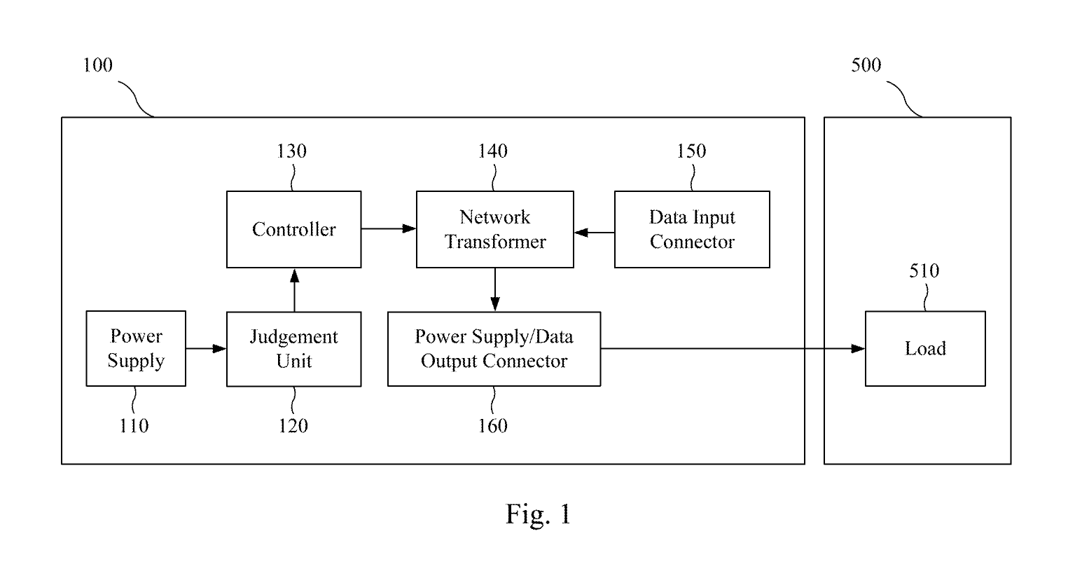

FIG. 1 is a block diagram of a power supply device 100 according to embodiments of the present invention. As shown in the figure, the power supply device 100 includes a power supply 110, a judgement unit 120, a controller 130, a network transformer 140, a data input connector 150 and a power supply/data output connector 160. With respect to structure, the judgement unit 120 is coupled between the power supply 110 and the controller 130, and the network transformer 140 is coupled between the controller 130, the data input connector 150 and the power supply/data output connector 160. Besides, a load system 500 is coupled to the power supply device 100 in a pluggable manner. Specifically, a load 510 of the load system 500 is coupled to the power supply/data output connector 160 of the power supply device 100 in a pluggable manner.

For confirming standard of power consumption with no load power acquired by the Department of Energy (DoE), the present disclosure provides a power supply device 100 as shown in FIG. 1, which will be described in detailed as shown below.

In one embodiment, the judgement unit 120 may be used to determine whether the power supply device 100 is coupled to the load 510. If the judgement unit 120 determines that the power supply device 100 is not coupled to the load 510, a definite time handshaking activation signal will be outputted so as to activate a definite time handshaking communication mode of the power supply device 100 for communicating with the load 510 in a definite time handshaking manner. In another embodiment, if the judgement unit 120 determines that the power supply device 100 is not coupled to the load 510, the definite time handshaking activation signal will be outputted to the controller 130. When the controller 130 receives the definite time handshaking activation signal outputted by the judgement unit 120, the controller 130 adopts the definite time handshaking communication mode for communicating with the load 510 in the definite time handshaking manner.

The definition of the definite time handshaking communication mode is used to be distinguished from a full time handshaking communication mode. Specifically, if the power supply device 100 is in condition of the full time handshaking communication mode, the power supply device 100 will continuously try to handshake with the load 510 when the load 510 is disconnected, so that the power supply device 100 will continuously consume the power. In another mode, if the load 510 is disconnected, the power supply device 100 will adopt a handshaking way with the load 510 in a periodical manner but not continuously try to handshake with the load 510 so as to achieve the goal of power saving. Such handshaking way is called the definite time handshaking communication mode.

In one embodiment, the definite time handshaking communication mode is that the controller 130 in the power supply device 100 communicates with the load 510 in the definite time handshaking manner every predetermined time. For example, the controller 130 in the power supply device 100 may communicate with the load 510 every 10 seconds during a fixed time period (i.e., 60 seconds). If the power consumption of the controller 130 is 100 mW (Watt), the power consumption of the controller 130 per second is 100 mW/10=10 mW. Besides, since the power supply device 100 adopts the definite time handshaking communication mode, the power consumption is only 80 mW during the controller 130 in the power supply device 100 does not activate the handshake manner. Therefore, the total power consumption of the controller 130 in the power supply device 100 is a sum of 10 mW and 80 mW, that is to say, 90 mW. Such power consumption confirms the standard of the power consumption with no load power acquired by the Department of Energy (DoE). The power consumption with no load power acquired by the DoE is less than 100 mW. In another embodiment, the power supply device 100 can be but not limited to Power over Ethernet (PoE) device, those skilled in the art may adopt any electronic device with a handshake manner according to actual requirements.

In still another embodiment, the definite time handshaking communication mode is that the controller 130 in the power supply device 100 outputs a definite time handshaking communication signal every predetermined time so as to communicate with the load 510 in the definite time handshaking manner. For example, the controller 130 in the power supply device 100 may output the definite time handshaking communication signal to the load 510 every 10 seconds during a fixed time period (i.e., 60 seconds) so as to communicate with the load 510 in definite time handshaking communication manner, rather than the definite time handshaking communication signal is outputted continuously for trying to communicate with the load 510, such that a power saving goal can be achieved.

In still another embodiment, the judgement unit 120 obtains an output current of the power supply device 100 for determining whether the power supply device 100 is coupled to the load 510. If the judgement unit 120 does not obtain the output current of the power supply device 100, it represents that the power supply device 100 is not coupled to the load 510, such that the power supply device 100 does not provide the output current to the load 510. In such condition, it is determined that the power supply device 100 is not coupled to the load 510.

In yet another embodiment, the judgement unit 120 determines whether the controller 130 of the power supply device 100 outputs the definite time handshaking communication signal repeatedly for determining whether the power supply device 100 is coupled to the load 510. If the judgement unit 120 determines that the power supply device 100 outputs the definite time handshaking communication signal repeatedly, it represents that the power supply device 100 does not receive the signal sent back by the load 510. In such condition, the power supply device 100 will output the definite time handshaking communication signal again, and the power supply device 100 will be determined that it is not coupled to the load 510.

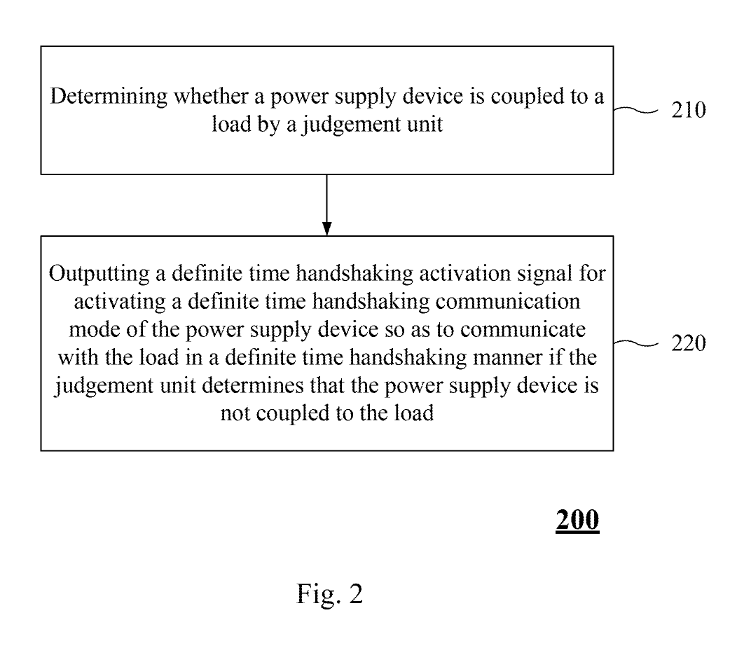

FIG. 2 is a flow diagram illustrating process steps of a control method 200 of a power supply device according to embodiments of the present disclosure. The control method 200 of the power supply device includes the following steps:

Step 210: determining whether the power supply device is coupled to a load by a judgement unit; and

Step 220: outputting a definite time handshaking activation signal for activating a definite time handshaking communication mode of the power supply device so as to communicate with the load in a definite time handshaking manner if the judgement unit determines that the power supply device is not coupled to the load.

For facilitating the understanding of the control method 200 of the power supply device, reference is now made to both FIG. 1 and FIG. 2. In step 210, the judgement unit 120 is configured to determine whether the power supply device 100 is coupled to the load 510. Subsequently, referring to step 220, if the judgement unit 120 determines that the power supply device 100 is not coupled to the load 510, the definite time handshaking activation signal is outputted for activating the definite time handshaking communication mode of the power supply device 100 so as to communicate with the load 510 in the definite time handshaking manner. In another embodiment, if the judgement unit 120 determines that the power supply device 100 is not coupled to the load 510, the definite time handshaking activation signal is outputted to the controller 130. When the controller 130 receives the definite time handshaking activation signal outputted by the judgement unit 120, the controller 130 adopts the definite time handshaking communication mode to communicate with the load 510 in the definite time handshaking manner.

It is noted that the definition of the definite time handshaking communication mode is described in the foregoing embodiments, and therefore, a detailed description will be omitted herein for the sake of brevity. The control method 200 of the power supply device of the present disclosure adopts the definite time handshaking communication mode as its basis, and therefore, if the load 510 is disconnected, the power supply device 100 will adopt a handshaking communication way in a periodical manner but not continuously try to handshake with the load 510, such that the goal of power saving can be achieved.

In step 220, the step of activating the definite time handshaking communication mode of the power supply device so as to communicate with the load in the definite time handshaking manner can be realized as shown below: the controller 130 of the power supply device 100 is configured to communicate with the load 510 in the definite time handshaking manner every predetermined time.

In another embodiment, referring to step 220, the step of activating the definite time handshaking communication mode of the power supply device so as to communicate with the load in the definite time handshaking manner can be realized as shown below: the controller 130 of the power supply device 100 is configured to output the definite time handshaking communication signal for communicating with the load 510 in the definite time handshaking manner every predetermined time.

Besides, in step 210, the step of determining whether the power supply device 100 is coupled to the load 510 by the judgement unit 120 can be realized as shown below: the judgement unit 120 is configured to obtain the output current of the power supply device 100 for determining whether the power supply device 100 is coupled to the load 510; if the judgement unit 120 does not obtain the output current of the power supply device 100, it is determined that the power supply device 100 is not coupled to the load 510.

In another embodiment, referring to step 210, the step of determining whether the power supply device 100 is coupled to the load 510 by the judgement unit 120 can be realized as shown below: the judgement unit 120 is configured to determine whether the controller 130 outputs a definite time handshaking communication signal repeatedly for determining whether the power supply device 100 is coupled to the load 510; if the judgement unit 120 determines that the controller 130 outputs the definite time handshaking communication signal repeatedly, it is determined that the power supply device 100 is not coupled to the load 510.

Those skilled in the art will appreciate that each of the steps of the control method 200 named after the function thereof is merely used to describe the technology in the embodiment of the present disclosure in detail, but the present disclosure is not limited in this regard. Therefore, combining the steps of said method into one step, dividing the steps into several steps, or rearranging the order of the steps is within the scope of the embodiment in the present disclosure.

In view of the above embodiments of the present disclosure, it is apparent that the application of the present invention has the advantages as follows. In view of the foregoing, embodiments of the present disclosure provide a judgement unit and a controlling method thereof, a power supply device and a controlling method thereof so as to confirm the standard of the power consumption acquired by the Department of Energy (DoE) when a load is disconnected with the power supply device.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A judgement unit applied in a Power over Ethernet (PoE) device, wherein the judgement unit is configured to determine whether the PoE device is coupled to a load;
wherein if the judgement unit determines that the PoE device is not coupled to the load, a definite time handshaking activation signal is outputted for activating a definite time handshaking communication mode of the PoE device so as to communicate with the load in a definite time handshaking manner.

2. The judgement unit of claim 1, wherein the definite time handshaking communication mode is communicating with the load in the definite time handshaking manner every predetermined time.

3. The judgement unit of claim 2, wherein the definite time handshaking communication mode is that a definite time handshaking communication signal is outputted every predetermined time so as to communicate with the load in the definite time handshaking manner.

4. The judgement unit of claim 1, wherein the judgement unit obtains an output current of the PoE device for determining whether the PoE device is coupled to the load, wherein if the judgement unit does not obtain the output current of the PoE device, it is determined that the PoE device is not coupled to the load.

5. The judgement unit of claim 1, wherein the judgement unit determines whether the PoE device outputs a definite time handshaking communication signal repeatedly for determining whether the PoE device is coupled to the load, wherein if the judgement unit determines that the PoE device outputs the definite time handshaking communication signal repeatedly, it is determined that the PoE device is not coupled to the load.

6. A power supply device for providing power to a load, comprising:
a judgement unit configured to determine whether the power supply device is coupled to the load, wherein if the judgement unit determines that the power supply device is not coupled to the load, a definite time handshaking activation signal is outputted; and
a controller coupled to the judgement unit, wherein if the controller receives the definite time handshaking activation signal outputted by the judgement unit, the controller adopts a definite time handshaking communication mode so as to communicate with the load in a definite time handshaking manner.

7. The power supply device of claim 6, wherein the controller communicates with the load in the definite time handshaking manner every predetermined time.

8. The power supply device of claim 7, wherein the controller outputs a definite time handshaking communication signal every predetermined time so as to communicate with the load in the definite time handshaking manner.

9. The power supply device of claim 6, wherein the judgement unit obtains an output current of the power supply device for determining whether the power supply device is coupled to the load, wherein if the judgement unit does not obtain the output current of the power supply device, it is determined that the power supply device is not coupled to the load.

10. The power supply device of claim 6, wherein the judgement unit determines whether the controller outputs a definite time handshaking communication signal repeatedly for determining whether the power supply device is coupled to the load, wherein if the judgement unit determines that the power supply device outputs the definite time handshaking communication signal repeatedly, it is determined that the power supply device is not coupled to the load.

11. A control method of a judgement unit applied in a Power over Ethernet (PoE) device, comprising:
determining whether the PoE device is coupled to a load by the judgement unit; and
outputting a definite time handshaking activation signal for activating a definite time handshaking communication mode of the PoE device so as to communicate with the load in a definite time handshaking manner if the judgement unit determines that the PoE device is not coupled to the load.

12. The control method of claim 11, wherein activating the definite time handshaking communication mode of the PoE device comprises:
activating the PoE device for communicating with the load in the definite time handshaking manner every predetermined time.

13. The control method of claim 11, wherein activating the PoE device for communicating with the load in the definite time handshaking manner every predetermined time comprises:
activating the PoE device for outputting a definite time handshaking communication signal every predetermined time so as to communicate with the load in the definite time handshaking manner.

14. The control method of claim 12, wherein determining whether the PoE device is coupled to the load by the judgement unit comprises:
obtaining an output current of the PoE device by the judgement unit for determining whether the PoE device is coupled to the load, wherein if the judgement unit does not obtain the output current of the PoE device, it is determined that the PoE device is not coupled to the load.

15. The control method of claim 12, wherein determining whether the PoE device is coupled to the load by the judgement unit comprises:
determining whether the PoE device outputs a definite time handshaking communication signal repeatedly by the judgement unit for determining whether the PoE device is coupled to the load, wherein if the judgement unit determines that the PoE device outputs the definite time handshaking communication signal repeatedly, it is determined that the PoE device is not coupled to the load.

16. A control method of a power supply device, wherein the power supply device is configured to provide power to a load, the power supply device comprises a judgement unit and a controller, and the judgement unit is coupled to the controller, wherein the control method comprises:
determining whether the power supply device is coupled to the load by the judgement unit;
outputting a definite time handshaking activation signal if the judgement unit determines that the power supply device is not coupled to the load; and
adopting a definite time handshaking communication mode by the controller so as to communicate with the load in a definite time handshaking manner if the controller receives the definite time handshaking activation signal outputted by the judgement unit.

17. The control method of claim 16, wherein adopting the definite time handshaking communication mode by the controller so as to communicate with the load in the definite time handshaking manner comprises:
communicating with the load in the definite time handshaking manner every predetermined time by the controller.

18. The control method of claim 16, wherein adopting the definite time handshaking communication mode by the controller so as to communicate with the load in the definite time handshaking manner comprises:
outputting a definite time handshaking communication signal every predetermined time by the controller so as to communicate with the load in the definite time handshaking manner.

19. The control method of claim 17, wherein determining whether the power supply device is coupled to the load by the judgement unit comprises:
obtaining an output current of the power supply device by the judgement unit for determining whether the power supply device is coupled to the load, wherein if the judgement unit does not obtain the output current of the power supply device, it is determined that the power supply device is not coupled to the load.

20. The control method of claim 17, wherein determining whether the power supply device is coupled to the load by the judgement unit comprises:
determining whether the controller outputs a definite time handshaking communication signal repeatedly by the judgement unit for determining whether the power supply device is coupled to the load, wherein if the judgement unit determines that the controller outputs the definite time handshaking communication signal repeatedly, it is determined that the power supply device is not coupled to the load.
